(19) United States
(12) Patent Application Publication
(10) Pub. No.: US 2024/0094387 A1
(43) Pub. Date: Mar. 21, 2024

(54) OPTICAL SENSING SYSTEM, OPTICAL SENSING DEVICE, AND OPTICAL SENSING METHOD

(71) Applicant: NEC Corporation, Tokyo (JP)

(72) Inventor: Takahiro Ono, Tokyo (JP)

(73) Assignee: NEC Corporation, Tokyo (JP)

(21) Appl. No.: 18/207,443

(22) Filed: Jun. 8, 2023

(30) Foreign Application Priority Data
Sep. 16, 2022 (JP) 2022-147845

(51) Int. Cl. G01S 17/34; G01S 7/481; G01S 7/4913

(52) U.S. Cl. CPC G01S 17/34; G01S 7/4817; G01S 7/4913

(57) ABSTRACT

The optical sensing system includes a three-dimensional scanner and a scanning density determination means. The three-dimensional scanner measures a distance to a measurement target by scanning the measurement target with a laser light and receiving reflected light of the laser light. The scanning density determination means dynamically determines a scanning density based on a distance to a distance measurement point or luminance of the reflected light during scanning of the three-dimensional scanner so as to suppress variation in a point cloud density caused by a length of the distance to the distance measurement point.

### INCORPORATION BY REFERENCE

This application is based upon and claims the benefit of priority from Japanese patent application No. 2022-147845, filed on Sep. 16, 2022, the disclosure of which is incorporated herein in its entirety by reference.

### TECHNICAL FIELD

The present disclosure relates to an optical sensing system, an optical sensing device, and an optical sensing method.

### BACKGROUND ART

International Patent Publication No. WO 2021/020570 discloses a Lidar (Light Detection and Ranging) scanner that scans a measurement target with a laser light, measures a distance to the measurement target based on reflected light of the laser light, and generates point cloud data based on a measurement result. The point cloud data is typically a set of point data including XYZ coordinate values.

### SUMMARY

In general, however, the point cloud density at points far from the Lidar scanner will be lower than the point cloud density at points near the Lidar scanner. This characteristic causes the following problems, for example.

If the point cloud density varies in the same point cloud data, inconvenience may occur in various analyses using the point cloud data. The various analyses are, for example, detection of cracks that may occur on the surface of a building as a measurement target.

Therefore, an object of the present disclosure is to provide a technique for suppressing a variation in point cloud density caused by a length of a distance to a distance measurement point.

An example object of the invention is to provide an optical sensing system, an optical sensing device, and an optical sensing method.

In a first example aspect, the optical sensing system includes a three-dimensional scanner configured to measure a distance to a measurement target by scanning the measurement target with a laser light and receiving reflected light of the laser light. The optical sensing system includes a scanning density determination unit for dynamically determining a scanning density based on a distance to a distance measurement point or luminance of the reflected light during scanning of the three-dimensional scanner so as to suppress variation in a point cloud density caused by a length of the distance to the distance measurement point.

In a second example aspect, the optical sensing device includes a three-dimensional scanner configured to measure a distance to a measurement target by scanning the measurement target with a laser light and receiving reflected light of the laser light. The optical sensing device includes a scanning density determination unit for dynamically determining a scanning density based on a distance to a distance measurement point or luminance of the reflected light during scanning of the three-dimensional scanner so as to suppress variation in a point cloud density caused by a length of the distance to the distance measurement point.

In a third example aspect, the optical sensing method includes a distance measurement step of measuring a distance to a measurement target by scanning the measurement target with a laser light and receiving reflected light of the laser light. The optical sensing method includes a scanning density determination step of dynamically determining a scanning density based on a distance to a distance measurement point or luminance of the reflected light during scanning in the distance measurement step so as to suppress variation in a point cloud density caused by a length of the distance to the distance measurement point.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a functional block diagram of an optical sensing system (Outline of present disclosure);

FIG. 2 is a functional block diagram of an optical sensing system (First example embodiment);

FIG. 3 is an operation flow of the optical sensing system (First example embodiment);

FIG. 4 is a functional block diagram of the optical sensing system (Third modified example); and

FIG. 5 is a functional block diagram of the optical sensing system (Second example embodiment).

### EXAMPLE EMBODIMENT

(Outline of Present Disclosure)

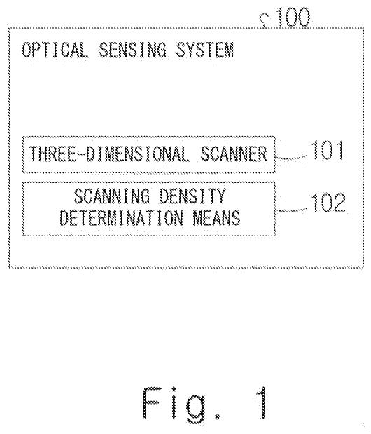

Hereinafter, an outline of the present disclosure will be described with reference to FIG. 1. FIG. 1 illustrates a functional block diagram of an optical sensing system.

As illustrated in FIG. 1, an optical sensing system 100 includes a three-dimensional scanner 101 and a scanning density determination means 102.

The three-dimensional scanner 101 measures the distance to the measurement target by scanning the measurement target with a laser light and receiving the reflected light of the laser light.

The scanning density determination means 102 dynamically determines the scanning density based on the distance to the distance measurement point or the luminance of the reflected light during the scanning of the three-dimensional scanner 101 so as to suppress the variation in the point cloud density caused by the length of the distance to the distance measurement point.

According to the above configuration, it is possible to suppress the variation in the point cloud density caused by the length of the distance to the distance measurement point.

### First Example Embodiment

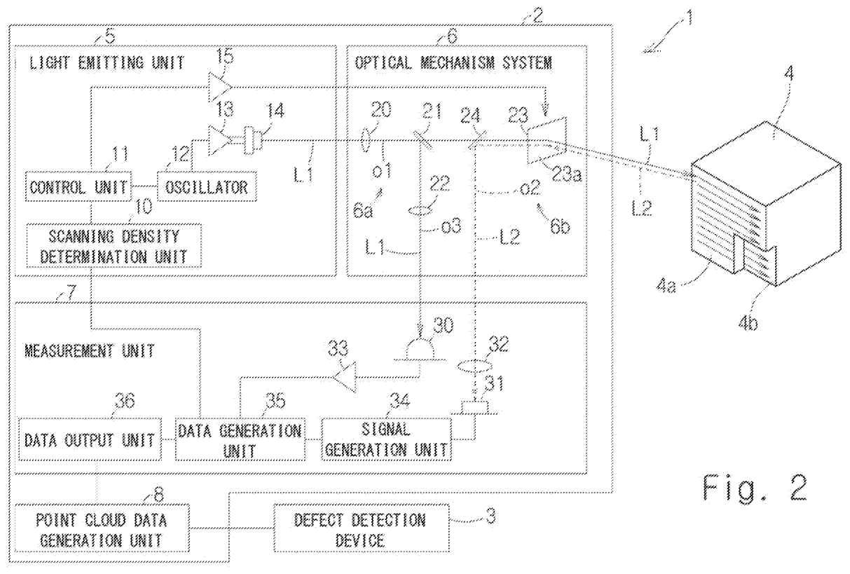

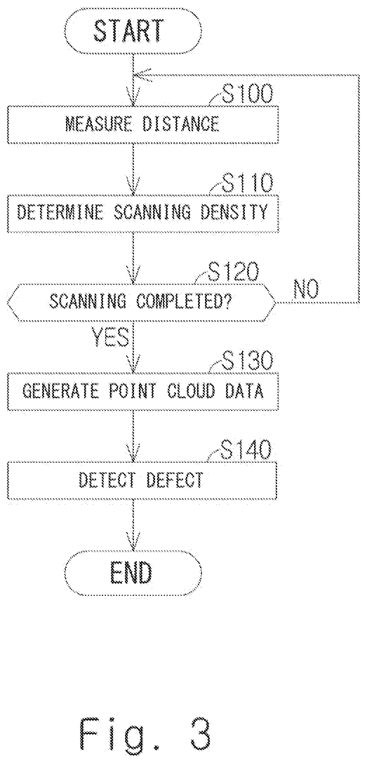

Next, a first example embodiment of the present disclosure will be described with reference to FIGS. 2 and 3.

FIG. 2 is a functional block diagram of an optical sensing system 1. As illustrated in FIG. 2, the optical sensing system 1 includes a three-dimensional Lidar scanner 2 and a defect detection device 3.

The three-dimensional Lidar scanner 2 generates point cloud data of a building 4 which is a specific example of a measurement target. The defect detection device 3 detects a surface defect such as a crack that may occur on the surface of the building 4 based on the point cloud data generated by the three-dimensional Lidar scanner 2. In the present example embodiment, the measurement target is assumed to be a stationary object. The stationary object includes, for example, an object having no movable portion such as a building and an object having a movable portion such as a movable bridge and being in a stationary state.

The three-dimensional Lidar scanner 2 includes a light emitting unit 5, an optical mechanism system 6, a measurement unit 7, and a point cloud data generation unit 8.

The light emitting unit 5 includes a scanning density determination unit 10, a control unit 11, an oscillator 12, a light source driver 13, a light source 14, and a scan driver 15.

The optical mechanism system 6 includes an irradiation optical system 6a and a light receiving optical system 6b. The irradiation optical system 6a includes a lens 20, a first optical element 21, a lens 22, and a mirror 23. The light receiving optical system 6b includes a second optical element 24 and a mirror 23. That is, the irradiation optical system 6a and the light receiving optical system 6b share the mirror 23.

The measurement unit 7 includes a photodetector 30, a sensor 31, a lens 32, an amplifier 33, a signal generation unit 34, a data generation unit 35, and a data output unit 36.

The scanning density determination unit 10 determines the scanning density, and outputs scanning density data indicating the determined scanning density to the control unit 11.

The control unit 11 controls the oscillator 12 based on the scanning density data input from the scanning density determination unit 10. The light source driver 13 drives the light source 14 based on the pulse signal generated by the oscillator 12. The light source 14 is, for example, a laser light source such as a laser diode. The light source 14 is driven by the light source driver 13 to intermittently emit a laser light L1. In the present example embodiment, the scanning density data is pulse period data indicating a pulse period of a pulse signal generated by the oscillator 12.

The light source 14, the lens 20, the first optical element 21, the second optical element 24, and the mirror 23 are arranged in this order on the optical axis O1 of the irradiation optical system 6a. The optical axis O1 can be defined as a focal axis of the lens 20 passing through the center position of the lens 20.

The lens 20 collimates the laser light L1 intermittently emitted from the light source 14 and guides the laser light L1 to the first optical element 21.

The first optical element 21 is typically a light splitter. The laser light L1 passes through the first optical element 21, is reflected by the first optical element 21, travels along the optical axis O3, and enters the photodetector 30.

The second optical element 24 is typically a half mirror. The laser light L1 passes through the second optical element 24 and enters the mirror 23.

The mirror 23 has a reflecting surface 23a that reflects the laser light L1 intermittently emitted from the light source 14. For example, the reflecting surface 23a is rotatable about two rotation axes crossing each other. Thus, the mirror 23 periodically changes the irradiation direction of the laser light L1. The mirror 23 is typically a polygon mirror driven by a motor. However, instead of this, micro electro mechanical systems (MEMS) may be adopted.

The control unit 11 outputs a drive signal to the scan driver 15 so that the inclination angle of the reflecting surface 23a of the mirror 23 periodically changes. The scan driver 15 drives the mirror 23 based on a drive signal input from the control unit 11. That is, the control unit 11 controls the irradiation direction of the laser light L1 by driving the scan driver 15.

FIG. 2 illustrates a raster scan method as a scanning method. However, instead of this, a conical scan method may be adopted.

The reflecting surface 23a of the mirror 23, the second optical element 24, the lens 32, and the sensor 31 are arranged on the optical axis O2 of the light receiving optical system 6b in order of incidence of the reflected light L2. The optical axis O2 can be defined as a focal axis of the lens 32 passing through the center position of the lens 32.

The reflecting surface 23a allows the reflected light L2 traveling along the optical axis O2 among the scattered light scattered by the building 4 to enter the second optical element 24. The second optical element 24 reflects the reflected light L2 reflected by the reflecting surface 23a to be incident on the lens 32 of the measurement unit 7 along the optical axis O2. The lens 32 condenses the reflected light L2 incident along the optical axis O2 on the sensor 31.

In FIG. 2, the optical path of the laser light L1 and the optical path of the reflected light L2 are separated from each other for clarity. In practice, however, they may overlap. In addition, an optical path at the center of the light flux of the laser light L1 is illustrated as the optical axis O1. Similarly, the optical path at the center of the light flux of the reflected light L2 is illustrated as the optical axis O2.

The sensor 31 is typically a photomultiplier. The sensor 31 converts the luminance of the reflected light L2 received via the light receiving optical system 6b into an electrical signal.

The measurement unit 7 measures the distance from the three-dimensional Lidar scanner 2 to the distance measurement point based on a luminance signal obtained by analog-digital conversion of an electrical signal obtained by converting the reflected light L2 into a signal. Specifically, it is as follows.

The signal generation unit 34 analog-to-digital converts the electrical signal output from the sensor 31 into a luminance signal. The signal generation unit 34 outputs the luminance signal to the data generation unit 35.

The data generation unit 35 measures the distance from the three-dimensional Lidar scanner 2 to the distance measurement point based on the time difference between the timing at which the photodetector 30 detects the laser light L1 and the timing at which the sensor 31 detects the reflected light L2 based on the luminance signal, and generates distance data. In addition, the data generation unit 35 generates luminance data indicating the luminance of the reflected light L2 detected by the sensor 31 based on the luminance signal. The data generation unit 35 outputs the distance data to the scanning density determination unit 10, and outputs the distance data and the luminance data to the data output unit 36.

The data output unit 36 outputs the distance data and the luminance data to the point cloud data generation unit 8.

The point cloud data generation unit 8 generates point cloud data based on the distance data and the luminance data input from the data output unit 36. The point cloud data is typically a set of point data having coordinate data and luminance data.

Next, the scanning density determination unit 10 will be described in detail. The scanning density determination unit 10 dynamically determines the scanning density based on the distance to the distance measurement point during the scanning of the three-dimensional Lidar scanner 2 so as to suppress the variation in the point cloud density caused by the length of the distance to the distance measurement point.

Here, the point cloud density can be defined as the number of distance measurement points per unit area in the measurement target.

The scanning density determination unit 10 dynamically determines the scanning density during the scanning of the three-dimensional Lidar scanner 2 based on the distance data input from the data generation unit 35 so as to suppress the above change. That is, the scanning density determination unit 10 determines the scanning density such that the distance from the three-dimensional Lidar scanner 2 to the distance measurement point and the scanning density have a positive correlation. In other words, the scanning density determination unit 10 relatively increases the scanning density when the distance from the three-dimensional Lidar scanner 2 to the distance measurement point is relatively long, and relatively decreases the scanning density when the distance from the three-dimensional Lidar scanner 2 to the distance measurement point is relatively short. The scanning density determination unit 10 outputs scanning density data indicating the determined scanning density to the control unit 11.

Here, the scanning density can be defined as the number of distance measurement points per unit solid angle viewed from the three-dimensional Lidar scanner 2. The scanning density may also be defined as the reciprocal of the angle between two line segments connecting two distance measurement points successively acquired by the three-dimensional Lidar scanner 2 to the three-dimensional Lidar scanner 2.

The three-dimensional Lidar scanner 2 of the present example embodiment employs a direct time of flight (dToF) method of irradiating the building 4 to be measured with a pulsed laser light L1. Therefore, in the case of increasing the scanning density, the three-dimensional Lidar scanner 2 typically shortens the pulse period of the pulsed laser light L1 with which the building 4 is irradiated. On the contrary, in the case of decreasing the scanning density, the three-dimensional Lidar scanner 2 typically increases the pulse period of the pulsed laser light L1 applied to the building 4. Therefore, the scanning density determination unit 10 dynamically determines the pulse period during the scanning of the three-dimensional Lidar scanner 2 based on the distance data input from the data generation unit 35 so as to suppress the above change. That is, the scanning density data in the present example embodiment is pulse period data indicating a pulse period.

Specifically, the scanning density determination unit 10 dynamically determines the pulse period during the scanning of the three-dimensional Lidar scanner 2 according to Equation (1) below. As described above, the three-dimensional Lidar scanner 2 repeats the scanning of the laser light L1 and the reception of the reflected light L2 to repeatedly measure the distance from the three-dimensional Lidar scanner 2 to the distance measurement point. In Equation (1), Tₙ is a pulse period between a pulse of the laser light L1 emitted from the light source 14 for the n-th measurement and a pulse of the laser light L1 emitted from the light source 14 for the (n−1)th measurement. T₀ and B are constants. rₙ₋₁ is distance data obtained by the (n−1)th measurement.

$$\begin{matrix}[ Mathematical Formula 1 ] & \\ {T}_{n} = {T}_{0} + \frac{1}{{BR}_{n - 1}} & ( 1 )\end{matrix}$$

According to Equation (1), it is possible to prevent a decrease in the point cloud density due to an increase in the distance from the three-dimensional Lidar scanner 2 to the distance measurement point during the scanning of the three-dimensional Lidar scanner 2. In other words, it is possible to prevent the variation in the point cloud density due to the variation in the distance from the three-dimensional Lidar scanner 2 to the distance measurement point during the scanning of the three-dimensional Lidar scanner 2.

That is, for example, as illustrated in FIG. 2, it is assumed that the measurement target surface of the building 4 is partially recessed, so that the building 4 has a surface 4a relatively close to the three-dimensional Lidar scanner 2 and a surface 4b relatively far from the three-dimensional Lidar scanner 2. In this case, when the scanning density is constant, the point cloud density on the surface 4b of the building 4 is lower than the point cloud density on the surface 4a of the building 4. Therefore, according to Equation (1), it is possible to prevent a decrease in the point cloud density due to an increase in the distance from the three-dimensional Lidar scanner 2 to the distance measurement point during the scanning of the three-dimensional Lidar scanner 2.

Next, an operation of the optical sensing system 1 will be described with reference to FIG. 3. FIG. 3 illustrates an operation flow of the optical sensing system 1.

As illustrated in FIG. 3, the control unit 11 executes (n−1)th distance measurement (S100). Next, the scanning density determination unit 10 substitutes the distance data obtained by the (n−1)th measurement into Equation (1) to determine the scanning density to be used after the n-th measurement (S110). Next, the control unit 11 determines whether scanning in a predetermined scanning range has been completed. When determining that the scanning is completed (S120: YES), the control unit 11 advances the processing to S130. On the other hand, when it is determined that the scanning is not completed (S120: NO), the control unit 11 returns the processing to S100 and executes n-th distance measurement. In S130, the point cloud data generation unit 8 generates the point cloud data based on the data output from the data output unit 36 (S130). Then, the defect detection device 3 detects a defect of the building 4 based on the point cloud data generated by the point cloud data generation unit 8 (S140). The defect of the building 4 is typically a surface defect such as a crack that may occur on the surface of the building 4. The point cloud density in the point cloud data generated by the point cloud data generation unit 8 of the present example embodiment is constant regardless of the length of the distance from the three-dimensional Lidar scanner 2. Therefore, the defect detection device 3 can detect the surface defect of the building 4 with high accuracy based on the point cloud data generated by the point cloud data generation unit 8.

The first example embodiment has been described above, and the first example embodiment has the following features.

The optical sensing system 1 includes the three-dimensional Lidar scanner 2 (three-dimensional scanner) and the scanning density determination unit 10 (scanning density determination means). The three-dimensional Lidar scanner 2 measures the distance to the building 4 by scanning the building 4 (measurement target) with the laser light L1 and receiving the reflected light L2 of the laser light. The scanning density determination unit 10 dynamically determines the scanning density based on the distance to the distance measurement point during the scanning of the three-dimensional Lidar scanner 2 so as to suppress the variation in the point cloud density caused by the length of the distance to the distance measurement point. The distance measurement point is a portion irradiated with the laser light L1 in the building 4. The distance measurement point is typically a portion irradiated with the laser light L1 on the wall surface of the building 4. For example, when there is a local recess on the wall surface of the building 4, the scanning density determination unit 10 dynamically determines the scanning density so that the scanning density when the laser light L1 is emitted to the inside of the recess becomes higher than the scanning density when the laser light L1 is emitted to the outside of the recess. Dynamically determining the scanning density means determining the scanning density in real time during the scanning of the three-dimensional Lidar scanner 2. According to the above configuration, it is possible to suppress the variation in the point cloud density caused by the length of the distance to the distance measurement point.

Furthermore, the scanning density determination unit 10 determines the scanning density so that the distance to the distance measurement point and the scanning density have a positive correlation. According to the above configuration, it is possible to effectively suppress the variation in the point cloud density caused by the length of the distance to the distance measurement point.

In addition, the three-dimensional Lidar scanner 2 increases or decreases the pulse period of the laser light L1 with which the building 4 is irradiated based on the scanning density determined by the scanning density determination unit 10. According to the above configuration, the scanning density determined by the scanning density determination unit 10 can be realized by simple control.

In addition, the optical sensing system 1 includes the point cloud data generation unit 8. The point cloud data generation unit 8 generates point cloud data based on the distance measured by the three-dimensional Lidar scanner 2. According to the above configuration, the point cloud data in which the variation in the point cloud density is suppressed is realized.

In the first example embodiment, the three-dimensional Lidar scanner 2 includes the scanning density determination unit 10 and the point cloud data generation unit 8. That is, the three-dimensional Lidar scanner 2, the scanning density determination unit 10, and the point cloud data generation unit 8 are realized by a single device. However, the three-dimensional Lidar scanner 2, the scanning density determination unit 10, and the point cloud data generation unit 8 may be realized by distributed processing by a plurality of devices. For example, a computer capable of performing bidirectional communication with the three-dimensional Lidar scanner 2 may function as the scanning density determination unit 10 and the point cloud data generation unit 8, and this computer may be a cloud computer.

### First Modified Example

Next, a first modified example of the first example embodiment will be described. The first example embodiment is as follows. That is, the scanning density determination unit 10 dynamically determines the scanning density based on the distance to the distance measurement point during the scanning of the three-dimensional Lidar scanner 2 so as to suppress the variation in the point cloud density caused by the length of the distance to the distance measurement point.

However, instead of this, the following may be applied. That is, the scanning density determination unit 10 dynamically determines the scanning density based on the luminance of the reflected light L2 during the scanning of the three-dimensional Lidar scanner 2 so as to suppress the variation in the point cloud density caused by the length of the distance to the distance measurement point. Specifically, the scanning density determination unit 10 determines the scanning density such that the luminance of the reflected light L2 and the scanning density have a negative correlation. That is, the scanning density determination unit 10 sets the scanning density to be relatively low when the luminance of the reflected light L2 is relatively high, and sets the scanning density to be relatively high when the luminance of the reflected light L2 is relatively low. This is because when the intensity of the laser light L1 emitted from the three-dimensional Lidar scanner 2 is constant, the luminance of the reflected light L2 increases or decreases according to the distance from the three-dimensional Lidar scanner 2 to the distance measurement point.

### Second Modified Example

Next, a second modified example of the first example embodiment will be described. The first example embodiment is as follows. That is, the scanning density determination unit 10 dynamically determines the scanning density based on the reciprocal of the distance from the three-dimensional Lidar scanner 2 to the distance measurement point.

However, instead of this, the following may be applied. That is, the scanning density determination unit 10 may dynamically determine the scanning density based on a comparison result obtained by comparing the distance from the three-dimensional Lidar scanner 2 to the distance measurement point with a predetermined value (first distance). Specifically, the scanning density determination unit 10 sets the scanning density to the first scanning density when the distance from the three-dimensional Lidar scanner 2 to the distance measurement point is longer than a predetermined value, and sets the scanning density to the second scanning density lower than the first scanning density when the distance is shorter than the predetermined value. According to the above configuration, it is possible to suppress the variation in the point cloud density caused by the length of the distance to the distance measurement point by extremely simple calculation.

The same applies to a case where the scanning density determination unit 10 dynamically determines the scanning density based on the luminance of the reflected light L2. That is, the scanning density determination unit 10 may dynamically determine the scanning density based on a comparison result obtained by comparing the luminance of the reflected light L2 with a predetermined value (first distance). Specifically, the scanning density is set to the first scanning density when the luminance of the reflected light L2 is lower than a predetermined value (first luminance), and the scanning density is set to the second scanning density lower than the first scanning density when the luminance is higher than the predetermined value. According to the above configuration, it is possible to suppress the variation in the point cloud density caused by the length of the distance to the distance measurement point by extremely simple calculation.

### Third Modified Example

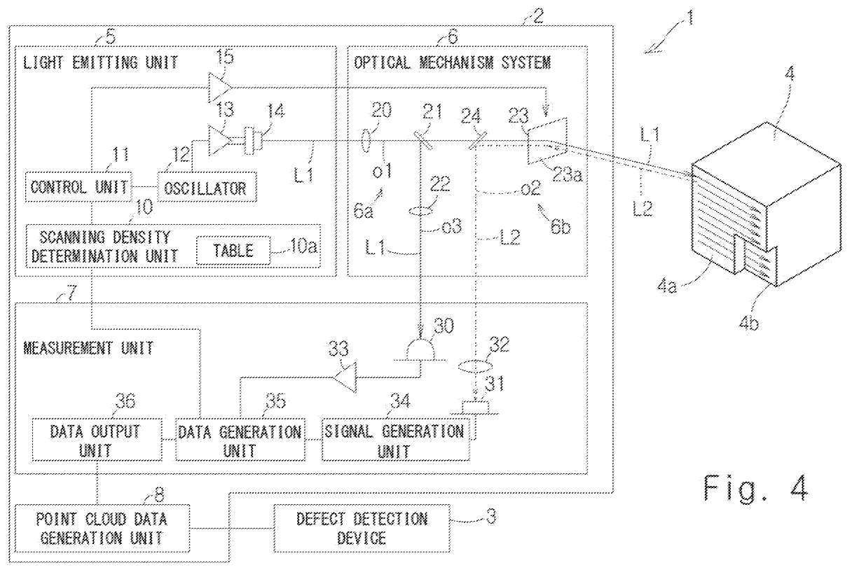

Next, a third modified example will be described with reference to FIG. 4. FIG. 4 is a functional block diagram of the optical sensing system 1.

As illustrated in FIG. 4, in the present modified example, the scanning density determination unit 10 includes a scanning density determination table 10a. The scanning density determination table 10a is a table indicating the correspondence relationship between the distance from the three-dimensional Lidar scanner 2 to the distance measurement point and the scanning density. In the scanning density determination table 10a, the distance from the three-dimensional Lidar scanner 2 to the distance measurement point and the scanning density have a positive correlation. Then, the scanning density determination unit 10 refers to the scanning density determination table 10a to dynamically determine the scanning density. According to the above configuration, it is possible to suppress the variation in the point cloud density caused by the length of the distance to the distance measurement point without requiring special calculation.

The same applies to a case where the scanning density determination unit 10 dynamically determines the scanning density based on the luminance of the reflected light L2. In this case, the scanning density determination table 10a indicates the correspondence relationship between the luminance of the reflected light L2 and the scanning density. In the scanning density determination table 10a, the luminance of the reflected light L2 and the scanning density have a negative correlation. Then, the scanning density determination unit 10 refers to the scanning density determination table 10a to dynamically determine the scanning density. According to the above configuration, it is possible to suppress the variation in the point cloud density caused by the length of the distance to the distance measurement point without requiring special calculation.

### Fourth Modified Example

Next, a fourth modified example of the first example embodiment will be described.

In the first example embodiment, when dynamically determining the scanning density, the scanning density determination unit 10 specifically determines the pulse period of the laser light L1 closely corresponding to the scanning density.

However, instead of this, the present modified example is as follows. That is, when determining the scanning density, the scanning density determination unit 10 specifically determines a scanning speed closely corresponding to the scanning density. That is, the scanning density determination unit 10 determines the scanning speed of the laser light L1 with which the building 4 is irradiated. The scanning speed of the laser light L1 is typically a rotation speed of a motor that drives a polygon mirror as the mirror 23.

The rotational speed and the scanning density have a negative correlation. That is, the scanning density is decreased when the rotation speed is increased, and the scanning density is increased when the rotation speed is decreased. Therefore, for example, in a case where the distance from the three-dimensional Lidar scanner 2 to the distance measurement point increases during the scanning of the three-dimensional Lidar scanner 2, the scanning density determination unit 10 decreases the rotation speed in order to increase the scanning density. Conversely, in a case where the distance from the three-dimensional Lidar scanner 2 to the distance measurement point decreases during the scanning of the three-dimensional Lidar scanner 2, the scanning density determination unit 10 increases the rotation speed in order to decrease the scanning density.

Specifically, the scanning density determination unit 10 dynamically determines the rotation speed according to Equation (2) below. As described above, the three-dimensional Lidar scanner 2 repeats the scanning of the laser light L1 and the reception of the reflected light L2 to repeatedly measure the distance from the three-dimensional Lidar scanner 2 to the distance measurement point. In Equation (2), Vₙ is a rotation speed at the time of the n-th measurement. V₀ and C are constants. rₙ₋₁ is distance data obtained by the (n−1)th measurement.

$$\begin{matrix}[ Mathematical Formula 2 ] & \\ {V}_{n} = {V}_{0} + \frac{1}{{Cr}_{n - 1}} & ( 2 )\end{matrix}$$

Then, the control unit 11 of the three-dimensional Lidar scanner 2 increases or decreases the scanning speed of the laser light L1 with which the building 4 is irradiated based on the scanning density determined by the scanning density determination unit 10. Specifically, the control unit 11 of the three-dimensional Lidar scanner 2 outputs a drive signal indicating the rotation speed determined by the scanning density determination unit 10 to the scan driver 15. According to the above configuration, the scanning density determined by the scanning density determination unit 10 can be reflected by simple control.

### Second Example Embodiment

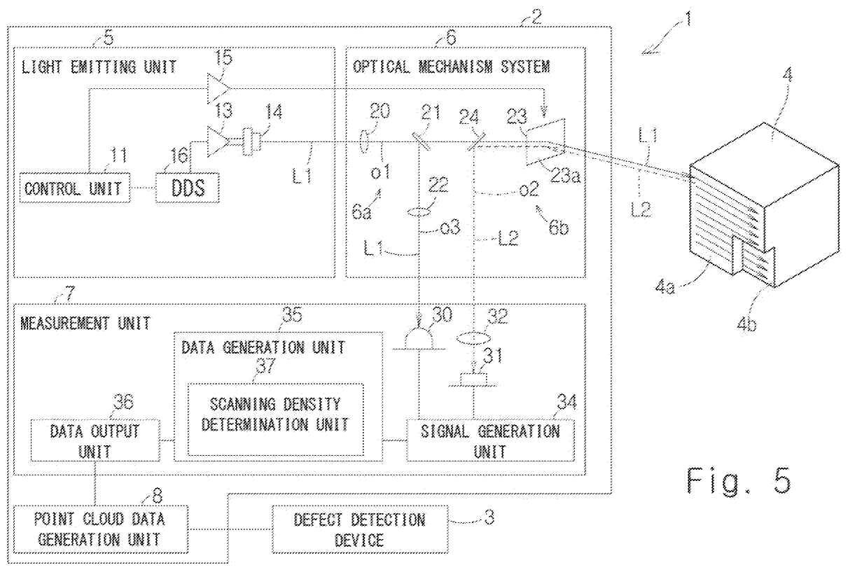

Next, a second example embodiment will be described with reference to FIG. 5. Hereinafter, differences between the first example embodiment and the present example embodiment will be mainly described, and redundant description will be omitted. In the present example embodiment, the three-dimensional Lidar scanner 2 adopts a frequency modulated continuous wave (FMCW) method. That is, the three-dimensional Lidar scanner 2 continuously irradiates the building 4 with a frequency-modulated laser light L1.

The light emitting unit 5 of the present example embodiment includes a direct digital synthesizer (DDS) 16 instead of the oscillator 12. The DDS 16 outputs a sweep signal whose frequency increases or decreases with time to the light source driver 13. As a result, the laser light L1 emitted from the light source 14 becomes a frequency-modulated continuous wave.

The emission signal output from the photodetector 30 and the light reception signal output from the sensor 31 are input to the signal generation unit 34 of the present example embodiment. Then, the signal generation unit 34 performs multiplication calculation on the emission signal and the light reception signal, and outputs an intermediate frequency signal (IF signal) that is a calculation result to the data generation unit 35.

The data generation unit 35 includes a scanning density determination unit 37. The scanning density determination unit 37 determines a sampling period of the intermediate frequency signal. The data generation unit 35 samples the intermediate frequency signal received from the signal generation unit 34 based on the sampling period determined by the scanning density determination unit 37. The data generation unit 35 measures the distance from the three-dimensional Lidar scanner 2 to the distance measurement point based on the sampled intermediate frequency signal and generates distance data. Then, the scanning density determination unit 37 determines the scanning density based on the distance from the three-dimensional Lidar scanner 2 to the distance measurement point. Specifically, the scanning density determination unit 37 determines the sampling period of the intermediate frequency signal closely corresponding to the scanning density. The scanning density and the sampling period have a negative correlation. That is, the sampling period may be shortened to increase the scanning density, and the sampling period may be lengthened to decrease the scanning density.

Specifically, the scanning density determination unit 37 dynamically determines the sampling period according to Equation (3) below. As described above, the three-dimensional Lidar scanner 2 repeatedly measures the distance from the three-dimensional Lidar scanner 2 to the distance measurement point by sampling the intermediate frequency signal. In Equation (3), Tₙ is a sampling period at the time of the n-th measurement. T₀ and D are constants. rₙ₋₁ is distance data obtained by the (n−1)th measurement.

$$\begin{matrix}[ Mathematical Formula 3 ] & \\ {T}_{n} = {T}_{0} + \frac{1}{{Dr}_{n - 1}} & ( 3 )\end{matrix}$$

According to Equation (3), it is possible to prevent a decrease in the point cloud density due to an increase in the distance from the three-dimensional Lidar scanner 2 to the distance measurement point during the scanning of the three-dimensional Lidar scanner 2. In other words, it is possible to prevent the variation in the point cloud density due to the variation in the distance from the three-dimensional Lidar scanner 2 to the distance measurement point during the scanning of the three-dimensional Lidar scanner 2. According to the above configuration, the scanning density determined by the scanning density determination unit 37 can be reflected by simple control.

The first example embodiment and the second example embodiment of the present disclosure have been described above. The first to fourth modified examples of the first example embodiment can be applied to the second example embodiment.

The present disclosure is not limited to the above example embodiment, and can be appropriately changed without departing from the gist.

For example, in each of the above example embodiments, the distance measurement method of the three-dimensional Lidar scanner 2 is a direct time of flight (dToF) method or a frequency modulated continuous wave (FMCW) method. However, instead of this, an Amplitude-modulated continuous wave (AMCW) may be adopted.

In each of the above example embodiments, one building, that is, the building 4 has been exemplified as an object to be measured by the three-dimensional Lidar scanner 2. However, the object to be measured by the three-dimensional Lidar scanner 2 may include a plurality of buildings. Examples of the plurality of buildings include a plurality of steel towers having different distances from the three-dimensional Lidar scanner 2 and a plurality of bridge piers (piers: so-called bridge lower structures) having different distances from the three-dimensional Lidar scanner 2. As described above, even in a case where the object to be measured by the three-dimensional Lidar scanner 2 includes a plurality of buildings, it is possible to suppress the variation in the point cloud density caused by the length of the distance to the distance measurement point.

Furthermore, for example, the scanning density determination unit 10 and the scanning density determination unit 37 may use a learned model learned so as to suppress variations in point cloud density due to the length of the distance from the three-dimensional Lidar scanner 2 to the distance measurement point during the scanning of the three-dimensional Lidar scanner 2. The scanning density determination unit 10 and the scanning density determination unit 37 dynamically determine the scanning density using the learned model. The learned model is typically a neural network that outputs a scanning density when a distance is input.

Furthermore, when determining the scanning density, the scanning density determination unit 10 and the scanning density determination unit 37 may express the determined scanning density at levels of 10 stages, for example.

The scanning density determination unit 10, the scanning density determination unit 37 and the point cloud data generation unit 8 may be realized in a hardware circuit, such as FPGA (Field Programmable Gate Array), ASIC (Application-Specific Integrated Circuit), Microcontroller, Microprocessor, Digital Signal Processor (DSP), GPU (Graphics Processing Unit).

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the exemplary embodiments disclosed above can be described as, but not limited to, the following supplementary notes.

(Supplementary Note 1)

An optical sensing system including:
a three-dimensional scanner configured to measure a distance to a measurement target by scanning the measurement target with a laser light and receiving reflected light of the laser light; and
a scanning density determination means for dynamically determining a scanning density based on a distance to a distance measurement point or luminance of the reflected light during scanning of the three-dimensional scanner so as to suppress variation in a point cloud density caused by a length of the distance to the distance measurement point.

(Supplementary Note 2)

The optical sensing system according to Supplementary note 1, wherein the scanning density determination means determines the scanning density such that the distance to the distance measurement point and the scanning density have a positive correlation, or determines the scanning density such that the luminance and the scanning density have a negative correlation.

(Supplementary Note 3)

The optical sensing system according to Supplementary note 2, wherein the scanning density determination means is configured to:
determine the scanning density as a first scanning density when the distance to the distance measurement point is longer than a first distance or when the luminance is lower than a first luminance; and
determine the scanning density as a second scanning density lower than the first scanning density when the distance to the distance measurement point is shorter than the first distance or when the luminance is higher than the first luminance.

(Supplementary Note 4)

The optical sensing system according to Supplementary note 2, wherein the scanning density determination means determines the scanning density by referring to a scanning density determination table indicating a correspondence relationship between the distance to the distance measurement point and the scanning density or a correspondence relationship between the luminance and the scanning density.

(Supplementary Note 5)

The optical sensing system according to any one of Supplementary notes 1 to 4, wherein when the three-dimensional scanner adopts a direct time of flight (dToF) method of irradiating the measurement target with a pulsed laser light,
the three-dimensional scanner increases or decreases a pulse period of the laser light with which the measurement target is irradiated based on the scanning density determined by the scanning density determination means.

(Supplementary Note 6)

The optical sensing system according to any one of Supplementary notes 1 to 4, wherein when the three-dimensional scanner adopts a frequency modulated continuous wave (FMCW) method of continuously irradiating the measurement target with a frequency-modulated laser light, the three-dimensional scanner increases or decreases a sampling period of an intermediate frequency signal based on the scanning density determined by the scanning density determination means.

(Supplementary Note 7)

The optical sensing system according to any one of Supplementary notes 1 to 4, wherein the three-dimensional scanner increases or decreases a scanning speed of the laser light with which the measurement target is irradiated based on the scanning density determined by the scanning density determination means.

(Supplementary Note 8)

The optical sensing system according to any one of Supplementary notes 1 to 4, further including a point cloud data generation means for generating point cloud data based on the distance measured by the three-dimensional scanner.

(Supplementary Note 9)

An optical sensing device including:
a three-dimensional scanner configured to measure a distance to a measurement target by scanning the measurement target with a laser light and receiving reflected light of the laser light; and
a scanning density determination means for dynamically determining a scanning density based on a distance to a distance measurement point or luminance of the reflected light during scanning of the three-dimensional scanner so as to suppress variation in a point cloud density caused by a length of the distance to the distance measurement point.

(Supplementary Note 10)

The optical sensing device according to Supplementary note 9, wherein the scanning density determination means determines the scanning density such that the distance to the distance measurement point and the scanning density have a positive correlation, or determines the scanning density such that the luminance and the scanning density have a negative correlation.

(Supplementary Note 11)

The optical sensing device according to Supplementary note 10, wherein the scanning density determination means is configured to:
determine the scanning density as a first scanning density when the distance to the distance measurement point is longer than a first distance or when the luminance is lower than a first luminance; and
determine the scanning density as a second scanning density lower than the first scanning density when the distance to the distance measurement point is shorter than the first distance or when the luminance is higher than the first luminance.

(Supplementary Note 12)

The optical sensing device according to Supplementary note 10, wherein the scanning density determination means determines the scanning density by referring to a scanning density determination table indicating a correspondence relationship between the distance to the distance measurement point and the scanning density or a correspondence relationship between the luminance and the scanning density.

(Supplementary Note 13)

The optical sensing device according to any one of Supplementary notes 9 to 12, wherein when the three-dimensional scanner adopts a direct time of flight (dToF) method of irradiating the measurement target with a pulsed laser light,
the three-dimensional scanner increases or decreases a pulse period of the laser light with which the measurement target is irradiated based on the scanning density determined by the scanning density determination means.

(Supplementary Note 14)

The optical sensing device according to any one of Supplementary notes 9 to 12, wherein when the three-dimensional scanner adopts a frequency modulated continuous wave (FMCW) method of continuously irradiating the measurement target with a frequency-modulated laser light,
the three-dimensional scanner increases or decreases a sampling period of an intermediate frequency signal based on the scanning density determined by the scanning density determination means.

(Supplementary Note 15)

The optical sensing device according to any one of Supplementary notes 9 to 12, wherein the three-dimensional scanner increases or decreases a scanning speed of the laser light with which the measurement target is irradiated based on the scanning density determined by the scanning density determination means.

(Supplementary Note 16)

The optical sensing device according to any one of Supplementary notes 9 to 12, further including a point cloud data generation means for generating point cloud data based on the distance measured by the three-dimensional scanner.

(Supplementary Note 17)

An optical sensing method including:
a distance measurement step of measuring a distance to a measurement target by scanning the measurement target with a laser light and receiving reflected light of the laser light; and
a scanning density determination step of dynamically determining a scanning density based on a distance to a distance measurement point or luminance of the reflected light during scanning in the distance measurement step so as to suppress variation in a point cloud density caused by a length of the distance to the distance measurement point.

(Supplementary Note 18)

The optical sensing method according to Supplementary note 17, wherein the scanning density determination step involves determining the scanning density such that the distance to the distance measurement point and the scanning density have a positive correlation, or determines the scanning density such that the luminance and the scanning density have a negative correlation.

(Supplementary Note 19)

The optical sensing method according to Supplementary note 18, wherein the scanning density determination step involves:
determining the scanning density as a first scanning density when the distance to the distance measurement point is longer than a first distance or when the luminance is lower than a first luminance; and
determining the scanning density as a second scanning density lower than the first scanning density when the distance to the distance measurement point is shorter than the first distance or when the luminance is higher than the first luminance.

(Supplementary Note 20)

The optical sensing method according to Supplementary note 18, wherein the scanning density determination step involves determining the scanning density by referring to a scanning density determination table indicating a correspondence relationship between the distance to the distance measurement point and the scanning density or a correspondence relationship between the luminance and the scanning density.

(Supplementary Note 21)

The optical sensing method according to any one of Supplementary notes 17 to 20, wherein when the distance measurement step adopts a direct time of flight (dToF) method of irradiating the measurement target with a pulsed laser light,
the distance measurement step involves increasing or decreasing a pulse period of the laser light with which the measurement target is irradiated based on the scanning density determined in the scanning density determination step.

(Supplementary Note 22)

The optical sensing method according to any one of Supplementary notes 17 to 20, wherein when the distance measurement step adopts a frequency modulated continuous wave (FMCW) method of continuously irradiating the measurement target with a frequency-modulated laser light,
the distance measurement step involves increasing or decreasing a sampling period of an intermediate frequency signal based on the scanning density determined in the scanning density determination step.

(Supplementary Note 23)

The optical sensing method according to any one of Supplementary notes 17 to 20, wherein the distance measurement step involves increasing or decreasing a scanning speed of the laser light with which the measurement target is irradiated based on the scanning density determined in the scanning density determination step.

(Supplementary Note 24)

The optical sensing method according to any one of Supplementary notes 17 to 20, further including a point cloud data generation step of generating point cloud data based on the distance measured in the distance measurement step.

(Supplementary Note 25)

A program for causing a computer to function as:
a three-dimensional scanner configured to measure a distance to a measurement target by scanning the measurement target with a laser light and receiving reflected light of the laser light; and
a scanning density determination means for dynamically determining a scanning density based on a distance to a distance measurement point or luminance of the reflected light during scanning of the three-dimensional scanner so as to suppress variation in a point cloud density caused by a length of the distance to the distance measurement point.

(Supplementary Note 26)

The program according to Supplementary note 25, wherein the scanning density determination means determines the scanning density such that the distance to the distance measurement point and the scanning density have a positive correlation, or determines the scanning density such that the luminance and the scanning density have a negative correlation.

(Supplementary Note 27)

The program according to Supplementary note 26, wherein the scanning density determination means is configured to:
determine the scanning density as a first scanning density when the distance to the distance measurement point is longer than a first distance or when the luminance is lower than a first luminance; and
determine the scanning density as a second scanning density lower than the first scanning density when the distance to the distance measurement point is shorter than the first distance or when the luminance is higher than the first luminance.

(Supplementary Note 28)

The program according to Supplementary note 26, wherein the scanning density determination means determines the scanning density by referring to a scanning density determination table indicating a correspondence relationship between the distance to the distance measurement point and the scanning density or a correspondence relationship between the luminance and the scanning density.

(Supplementary Note 29)

The program according to any one of Supplementary notes 25 to 28, wherein when the three-dimensional scanner adopts a direct time of flight (dToF) method of irradiating the measurement target with a pulsed laser light,
the three-dimensional scanner increases or decreases a pulse period of the laser light with which the measurement target is irradiated based on the scanning density determined by the scanning density determination means.

(Supplementary Note 30)

The program according to any one of Supplementary notes 25 to 28, wherein when the three-dimensional scanner adopts a frequency modulated continuous wave (FMCW) method of continuously irradiating the measurement target with a frequency-modulated laser light,
the three-dimensional scanner increases or decreases a sampling period of an intermediate frequency signal based on the scanning density determined by the scanning density determination means.

(Supplementary Note 31)

The program according to any one of Supplementary notes 25 to 28, wherein the three-dimensional scanner increases or decreases a scanning speed of the laser light with which the measurement target is irradiated based on the scanning density determined by the scanning density determination means.

(Supplementary Note 32)

The program according to any one of Supplementary notes 25 to 28, causing the computer to further function as:
a point cloud data generation means for generating point cloud data based on the distance measured by the three-dimensional scanner.

An example advantage according to the above-described embodiments is that it is possible to suppress variation in the point cloud density due to the length of the distance to the distance measurement point.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An optical sensing system comprising:
a three-dimensional scanner configured to measure a distance to a measurement target by scanning the measurement target with a laser light and receiving reflected light of the laser light, and
a scanning density determination circuit configured to dynamically determine a scanning density based on a distance to a distance measurement point or luminance of the reflected light during scanning of the three-dimensional scanner so as to suppress variation in a point cloud density caused by a length of the distance to the distance measurement point.

2. The optical sensing system according to claim 1, wherein the scanning density determination circuit is further configured to determine the scanning density such that the distance to the distance measurement point and the scanning density have a positive correlation, or determines the scanning density such that the luminance and the scanning density have a negative correlation.

3. The optical sensing system according to claim 2, wherein the scanning density determination circuit is further configured to:
determine the scanning density as a first scanning density when the distance to the distance measurement point is longer than a first distance or when the luminance is lower than a first luminance; and
determine the scanning density as a second scanning density lower than the first scanning density when the distance to the distance measurement point is shorter than the first distance or when the luminance is higher than the first luminance.

4. The optical sensing system according to claim 2, wherein the scanning density determination circuit is further configured to determine the scanning density by referring to a scanning density determination table indicating a correspondence relationship between the distance to the distance measurement point and the scanning density or a correspondence relationship between the luminance and the scanning density.

5. The optical sensing system according to claim 1, wherein when the three-dimensional scanner adopts a direct time of flight (dToF) method of irradiating the measurement target with a pulsed laser light,
the three-dimensional scanner increases or decreases a pulse period of the laser light with which the measurement target is irradiated based on the scanning density determined by the scanning density determination circuit.

6. The optical sensing system according to claim 1, wherein when the three-dimensional scanner adopts a frequency modulated continuous wave (FMCW) method of continuously irradiating the measurement target with a frequency-modulated laser light,
the three-dimensional scanner increases or decreases a sampling period of an intermediate frequency signal based on the scanning density determined by the scanning density determination circuit.

7. The optical sensing system according to claim 1, wherein the three-dimensional scanner increases or decreases a scanning speed of the laser light with which the measurement target is irradiated based on the scanning density determined by the scanning density determination circuit.

8. The optical sensing system according to claim 1, further comprising a point cloud data generation circuit configured to generate point cloud data based on the distance measured by the three-dimensional scanner.

9. An optical sensing device comprising:
a three-dimensional scanner configured to measure a distance to a measurement target by scanning the measurement target with a laser light and receiving reflected light of the laser light, and
a scanning density determination circuit configured to dynamically determine a scanning density based on a distance to a distance measurement point or luminance of the reflected light during scanning of the three-dimensional scanner so as to suppress variation in a point cloud density caused by a length of the distance to the distance measurement point.

10. The optical sensing device according to claim 9, wherein the scanning density determination circuit is further configured to determine the scanning density such that the distance to the distance measurement point and the scanning density have a positive correlation, or determines the scanning density such that the luminance and the scanning density have a negative correlation.

11. The optical sensing device according to claim 10, wherein the scanning density determination circuit is further configured to:
determine the scanning density as a first scanning density when the distance to the distance measurement point is longer than a first distance or when the luminance is lower than a first luminance; and
determine the scanning density as a second scanning density lower than the first scanning density when the distance to the distance measurement point is shorter than the first distance or when the luminance is higher than the first luminance.

12. The optical sensing device according to claim 10, wherein the scanning density determination circuit is further configured to determine the scanning density by referring to a scanning density determination table indicating a correspondence relationship between the distance to the distance measurement point and the scanning density or a correspondence relationship between the luminance and the scanning density.

13. The optical sensing device according to claim 9, further comprising a point cloud data generation circuit configured to generate point cloud data based on the distance measured by the three-dimensional scanner.

14. An optical sensing method comprising:
measuring a distance to a measurement target by scanning the measurement target with a laser light and receiving reflected light of the laser light; and
dynamically determining a scanning density based on a distance to a distance measurement point or luminance of the reflected light during scanning in the measuring so as to suppress variation in a point cloud density caused by a length of the distance to the distance measurement point.

15. The optical sensing method according to claim 14, wherein the dynamically determining involves determining the scanning density such that the distance to the distance measurement point and the scanning density have a positive correlation, or determines the scanning density such that the luminance and the scanning density have a negative correlation.

16. The optical sensing method according to claim 15, wherein the dynamically determining involves:
determining the scanning density as a first scanning density when the distance to the distance measurement point is longer than a first distance or when the luminance is lower than a first luminance; and
determining the scanning density as a second scanning density lower than the first scanning density when the distance to the distance measurement point is shorter than the first distance or when the luminance is higher than the first luminance.

17. The optical sensing method according to claim 15, wherein the dynamically determining involves determining the scanning density by referring to a scanning density determination table indicating a correspondence relationship between the distance to the distance measurement point and the scanning density or a correspondence relationship between the luminance and the scanning density.

18. The optical sensing method according to claim 14, further comprising generating point cloud data based on the distance measured in the measuring.
